(19) United States
(12) Patent Application Publication
(10) Pub. No.: US 2012/0008805 A1
(43) Pub. Date: Jan. 12, 2012

(54) Acoustic Transducer Unit

(75) Inventors: Satoru Hachinohe, Nagaokakyo-Shi (JP); Kazumasa Haruta, Nagaokakyo-Shi (JP); Takahiro Oguchi, Nagaokakyo-Shi (JP)

(73) Assignee: Murata Manufacturing Co., Ltd.

(21) Appl. No.: 13/207,548

(22) Filed: Aug. 11, 2011

Related U.S. Application Data
(63) Continuation of application No. PCT/JP2009/006744, filed on Dec. 10, 2009.
Application No. PCT/JP2009/006744 is a continuation of application No. PCT/JP2010/052204, filed on Feb. 15, 2010.

(30) Foreign Application Priority Data
Feb. 17, 2009 (JP) 2009-034601

(51) Int. Cl. H04R 1/00

(52) U.S. Cl. 381/163

(57) ABSTRACT

An acoustic transducer unit that includes (a) an acoustic transducer having an acoustic transducer portion that converts sound into an electrical signal or converts an electrical signal into sound, and (b) packages that accommodate the acoustic transducer. The packages include a cylindrical conductive portion formed of a conductive material and having an inner space with both end apertures. At least the acoustic transducer portion of the acoustic transducer is located in the inner space of the conductive portion such as to be spaced from the apertures.

### CROSS REFERENCE TO RELATED APPLICATIONS

The present application is a continuation of International Application No. PCT/JP2009/006744, filed Dec. 10, 2009, and a continuation of International Application No. PCT/JP2010/052204, filed Feb. 15, 2010, which each claim priority to Japanese Patent Application No. JP2009-034601, filed Feb. 17, 2009, the entire contents of each of these applications being incorporated herein by reference in their entirety.

### FIELD OF THE INVENTION

The present invention relates to acoustic transducer units, and more particularly, to an acoustic transducer unit in which an acoustic transducer, such as a microphone or a speaker, is stored in a housing.

### BACKGROUND OF THE INVENTION

There has been hitherto proposed a structure of an acoustic transducer unit in which an acoustic transducer is covered with an electromagnetic shield member in order to prevent an electromagnetic interference signal (noise) from invading.

For example, as illustrated in FIG. 13 serving as a cross-sectional view, an acoustic transducer 210 is mounted together with another component 220 on an upper surface of a board 120 having connecting terminals 123 and 125 on a lower surface. A metal case 110 having acoustic holes 110a is fixed at provisional welding points 130 to a connecting pattern 121 provided on the upper surface of the board 120, and is fixed with an adhesive 140 applied on the entire joint surface. The connecting pattern 121 is connected to the connecting terminal 125 by a through-hole 124. The acoustic transducer 210 is located in an inner space 150 of the metal case 110, and is thereby shielded from external electromagnetic waves (for example, see Patent Literature 1).
Patent Literature 1: Japanese Unexamined Patent Application Publication No. 2007-82233

### SUMMARY OF THE INVENTION

When the acoustic transducer is thus mounted on the board and is entirely covered with the electromagnetic shield member such as the metal case illustrated in FIG. 13, the structure is complicated, and reduction of production cost is difficult. Moreover, it is not easy to reduce the size and height.

In view of such circumstances, the present invention provides an acoustic transducer unit that can achieve electromagnetic shielding with a simple structure.

To solve the above problems, the present invention provides an acoustic transducer unit configured as follows.

An acoustic transducer unit includes (a) an acoustic transducer having an acoustic transducer portion that converts sound into an electrical signal or converts an electrical signal into sound; and (b) a package that accommodates the acoustic transducer. The package includes a cylindrical conductive portion formed of a conductive material and having an inner space with both end apertures. At least the acoustic transducer portion of the acoustic transducer is located in the inner space of the conductive portion such as to be spaced from the apertures.

When an acoustic transducer, such as a microphone element, is electromagnetically shielded in the related art, the acoustic transducer is entirely surrounded by an electromagnetic shield member such as a metal case. This structure is adopted because it has been vaguely considered that it is necessary to surround the entire acoustic transducer with the electromagnetic shield member in order to obtain a sufficient function of cutting off electromagnetic waves.

However, considering the function as the acoustic transducer unit such as a microphone, the frequency band that needs to be cut off is limited. Hence, an electromagnetic interference signal (noise) can be cut off as long as an electromagnetic wave component in a low-frequency band concerning sound (sound region) can be attenuated. With attention to this point, the present inventor adopts, in the acoustic transducer unit of the present invention, a cylindrical conductive portion that can obtain large attenuation in the low-frequency band for electromagnetic shielding.

That is, in the above-described configuration of the present invention, the cylindrical conductive portion having both end apertures can be designed to exhibit a sufficient attenuation characteristic at least for an electromagnetic wave passing through the inner space between the apertures of the conductive portion, where the acoustic transducer portion of the acoustic transducer is located, in a low-frequency band where an electromagnetic interference signal (noise) causes a problem (e.g., 50 kHz or less) in the acoustic transducer unit.

According to the above structure, since the entire periphery of the acoustic transducer does not need to be covered, the structure can be simplified, and the production cost can be reduced. Moreover, size reduction is easy.

Preferably, the conductive portion is buried in a resin main body of the package.

In this case, the acoustic transducer unit can be produced at low cost, for example, by insert molding, and size reduction is easy.

In a preferred embodiment, the package includes (a) a first member having a concave portion in which the acoustic transducer is provided, (b) a second member connected to the first member to cover the concave portion, and (c) a terminal member extending through the first member, and having one end portion projecting in the concave portion such as to be electrically connected to the acoustic transducer and the other end portion exposed outside. The one end portion of the terminal member projecting in the concave portion elastically deforms to press the acoustic transducer against the second member.

In this case, variations in component dimensions can be absorbed by springiness of the terminal member. Further, characteristic variations can be reduced by pressing the acoustic transducer against the second member.

In another preferred embodiment, the package includes (a) a first member having a concave portion in which the acoustic transducer is provided, (b) a second member having a pair of principal surfaces, one of the principal surfaces being connected to the first member to cover the concave portion, and (c) a terminal member extending through the first member, and having one end portion projecting in the concave portion such as to be electrically connected to the acoustic transducer and the other end portion exposed outside. The other end portion of the terminal member extends along outer peripheral surfaces of the first member and the second member to the other of the principal surfaces of the second member.

In this case, an external terminal portion for connecting the acoustic transducer to an external circuit can be formed in the second member by extending and folding the other end portion of the terminal member. Since this allows the components to be shared with another type of acoustic transducer unit having an external terminal portion in a first member, a plurality of types of acoustic transducer units, which are different in the arrangement of the external terminal portion, can be produced at low cost.

To solve the above problems, the present invention also provides an acoustic transducer unit configured as follows.

An acoustic transducer unit includes (a) an acoustic transducer having an acoustic transducer portion that converts sound into an electrical signal or converts an electrical signal into sound; and (b) a package that accommodates the acoustic transducer. The package includes a cylindrical conductive portion formed of a conductive material and having an inner space with both end apertures, and a nonconductive portion formed of only an insulating material such as to cover the apertures. At least the acoustic transducer portion of the acoustic transducer is located in the inner space of the conductive portion such as to be spaced from the apertures.

In the above-described configuration, the cylindrical conductive portion having both end apertures can be designed to exhibit a sufficient attenuation characteristic at least for an electromagnetic wave passing through the inner space between the apertures of the conductive portion, where the acoustic transducer portion of the acoustic transducer is located, in a low-frequency band where an electromagnetic interference signal (noise) causes a problem (e.g., 50 kHz or less) in the acoustic transducer unit.

According to the above structure, the package includes the cylindrical conductive portion formed of a conductive material and having the inner space with both end apertures, and the nonconductive portion formed of only an insulating material such as to cover the apertures. The acoustic transducer located in the inner space of the conductive portion is covered with the conductive portion except at the apertures of the conductive portion. Since the entire periphery of the acoustic transducer does not need to be covered, the structure can be simplified, and the production cost can be reduced. Moreover, size reduction is easy.

Preferably, the conductive portion is buried in a resin main body of the package.

In this case, the acoustic transducer unit can be produced at low cost, for example, by insert molding. Moreover, size reduction is easy.

In a preferred embodiment, the package includes (a) a first member having a concave portion in which the acoustic transducer is provided, and (b) a plate-shaped second member formed of only an insulating material and connected to the first member such as to cover an aperture of the concave portion. The package includes a terminal member extending through the first member, and having one end portion projecting in the concave portion such as to be electrically connected to the acoustic transducer and the other end portion exposed outside. The one end portion of the terminal member projecting in the concave portion elastically deforms to press the acoustic transducer against the second member.

In this case, variations in component dimensions can be absorbed by springiness of the terminal member. Further, characteristic variations can be reduced by pressing the acoustic transducer against the second member.

In a further preferred embodiment, the package includes (a) a first member having a concave portion in which the acoustic transducer is provided, and (b) a second member having a pair of principal surfaces, one of the principal surfaces being connected to the first member to cover the concave portion. The package includes a terminal member extending through the first member, and having one end portion projecting in the concave portion such as to be electrically connected to the acoustic transducer and the other end portion exposed outside. The other end portion of the terminal member extends along outer peripheral surfaces of the first member and the second member to the other of the principal surfaces of the second member.

In this case, an external terminal portion for connecting the acoustic transducer to an external circuit can be formed in the second member by extending and folding the other end portion of the terminal member. Since this allows the components to be shared with another type of acoustic transducer unit having an external terminal portion in a first member, a plurality of types of acoustic transducer units, which are different in the arrangement of the external terminal portion, can be produced at low cost.

The acoustic transducer unit of the present invention can achieve electromagnetic shielding with a simple structure. For this reason, it is easy to reduce the production cost, size, and height.

### BRIEF DESCRIPTION OF THE DRAWINGS

FIG. 1 is a perspective view of an acoustic transducer unit (first embodiment).

FIGS. 2(a) and 2(b) are an exploded cross-sectional view and a cross-sectional assembly view, respectively, of the acoustic transducer unit (first embodiment).

FIG. 3 is a cross-sectional view of an acoustic transducer unit (second embodiment).

FIG. 4 is a cross-sectional view of an acoustic transducer unit (third embodiment).

FIG. 5 is a cross-sectional view of an acoustic transducer unit (fourth embodiment).

FIG. 6 is a cross-sectional view of an acoustic transducer unit (first modification).

FIG. 7 is a cross-sectional view of an acoustic transducer unit (second modification).

FIG. 8 is a cross-sectional view of an acoustic transducer unit (second modification).

FIG. 9 is a cross-sectional view of an acoustic transducer unit (second modification).

FIG. 10 is a cross-sectional view of an acoustic transducer unit (second modification).

FIG. 11 is a graph showing the attenuation characteristic (first embodiment).

FIG. 12 is a perspective view of a conductive portion (first embodiment).

FIG. 13 is a cross-sectional view of an acoustic transducer unit (related art).

### DETAILED DESCRIPTION OF THE INVENTION

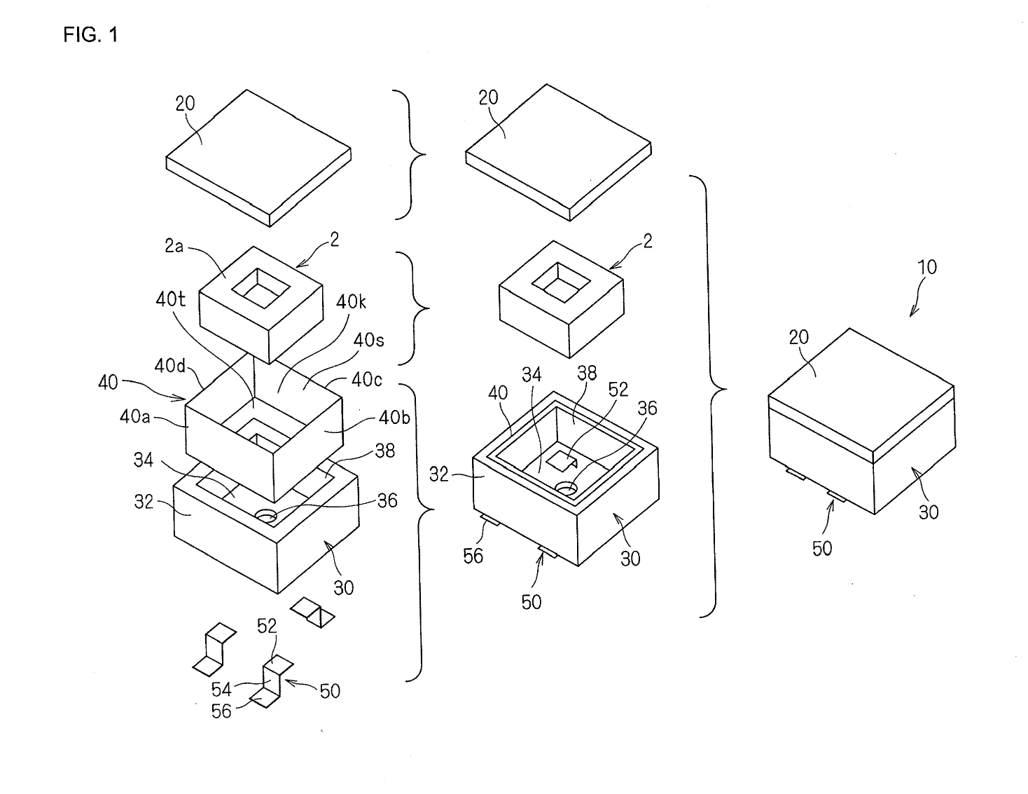

Embodiments of the present invention will be described below with reference to FIGS. 1 to 12.

### First Embodiment

An acoustic transducer unit 10 according to an embodiment will be described with reference to FIGS. 1, 2, 11, and 12.

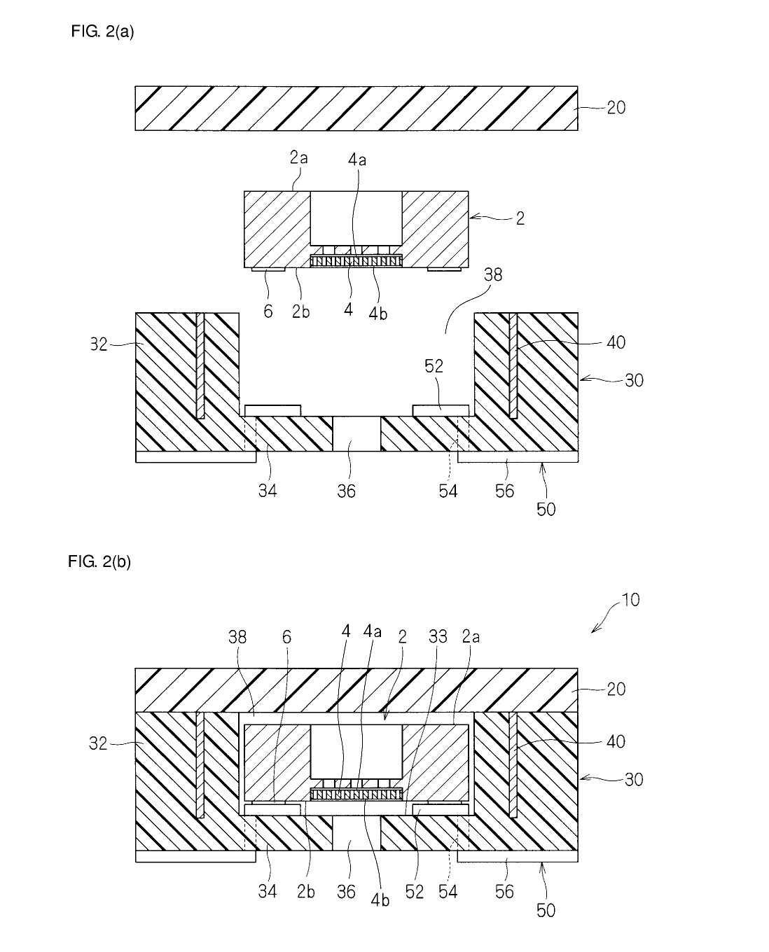

FIG. 1 is a perspective view illustrating a configuration of the acoustic transducer unit 10. FIG. 2(a) is an exploded cross-sectional view of the acoustic transducer unit 10. FIG. 2(b) is a cross-sectional assembly view of the acoustic transducer unit 10.

Roughly, as illustrated in FIGS. 1 and 2, in the acoustic transducer unit 10, a microphone element 2 serving as an acoustic transducer is stored in a housing defined by a first member 30 and a second member 20.

An electromagnetic shield member 40 and terminal members 50 are provided integrally with a main body of the first member 30 that is formed of only resin by joining a cylindrical portion 32 and a bottom portion 34, for example, by insert molding. As illustrated in FIG. 2, the first member 30 has a concave portion 38 defined by the cylindrical portion 32 and the bottom portion 34. The electromagnetic shield member 40 is buried in the cylindrical portion 32. Middle portions 54 of the terminal members 50 are buried in the bottom portion 34. The microphone element 2 is mounted on the bottom portion 34 of the first member 30. The bottom portion 34 has a through-hole 36 serving as an acoustic path.

The second member 20 is formed of only an insulating material such as resin. As illustrated in FIG. 2(b), the second member 20 is joined to the first member 30 to cover the concave portion 38 of the first member 30, for example, with adhesive, or by thermo-compression bonding or heat sealing, whereby the microphone element 2 is sealed in the concave portion 38 of the first member 30.

As illustrated in FIG. 1, the electromagnetic shield member 40 is a cylindrical member defined by four flat portions 40a to 40d joined to form a rectangular section. The electromagnetic shield member 40 includes apertures 40s and 40t provided at opposite ends, and an inner space 40k extending between the apertures 40s and 40t. The electromagnetic shield member 40 is formed of a conductive material such as metal. The electromagnetic shield member 40 is a cylindrical conductive portion including the inner space having the apertures at the opposite ends and formed of a conductive material. For example, in the electromagnetic shield member 40, the four flat portions 40a to 40d are formed by flat plates of metal such as gold, and the apertures 40s and 40t has a size of 2 mm×2 mm.

One aperture 40s of the electromagnetic shield member 40 is covered with the second member 20 serving as a nonconductive portion. The other aperture 40t of the electromagnetic shield member 40 is covered with the bottom portion 34 of the first member 30 serving as a nonconductive portion.

As illustrated in FIGS. 1 and 2, the terminal members 50 each include an internal terminal portion 52 extending in the concave portion 38 of the first member 30, an external terminal portion 56 extending in an outer space outside the housing, and a middle portion 54 that connects the internal terminal portion 52 and the external terminal portion 56. The terminal members 50 are formed of a conductive material such as metal, for example, copper.

As illustrated in FIG. 2(b), connecting terminals 6 of the microphone element 2 are connected to the internal terminal portions 52. Connection can be made by using Au bumps, solder bumps, conductive paste, nanopaste, etc.

The external terminal portions 56 are electrically connected to an unillustrated external circuit when the acoustic transducer unit 10 is mounted on the unillustrated external circuit.

As illustrated in FIG. 2, the microphone element 2 is a module component including an acoustic transducer portion (sensor portion) 4 for converting sound into an electrical signal and a peripheral circuit, and is, for example, a MEMS microphone, an electret condenser microphone (ECM), or a piezoelectric microphone. Instead of the microphone element 2, an acoustic transducer for converting an electrical signal into sound, such as a speaker element, may be used.

The microphone element 2 is located in the inner space 40k defined by the cylindrical electromagnetic shield member 40. At least the acoustic transducer portion 4 of the microphone element 2 is spaced from the apertures 40s and 40t of the electromagnetic shield member 40. This electromagnetically shields the microphone element 2.

That is, since the electromagnetic shield member 40 is formed of a conductive material, an electromagnetic wave passing through the electromagnetic shield member 40 itself is cut off. An electromagnetic wave, which enters from the aperture 40s or 40t of the electromagnetic shield member 40 and travels in the inner space 40k defined by the electromagnetic shield member 40, can be such that a component thereof in a low-frequency band (e.g., 50 kHz or less), where an electromagnetic interference signal (noise) is a problem, can attenuate in the acoustic transducer unit 10 until the electromagnetic wave reaches the acoustic transducer portion 4 of the microphone element 2. A high-frequency component that does not attenuate can be cut off by a low-pass filter or the like as required.

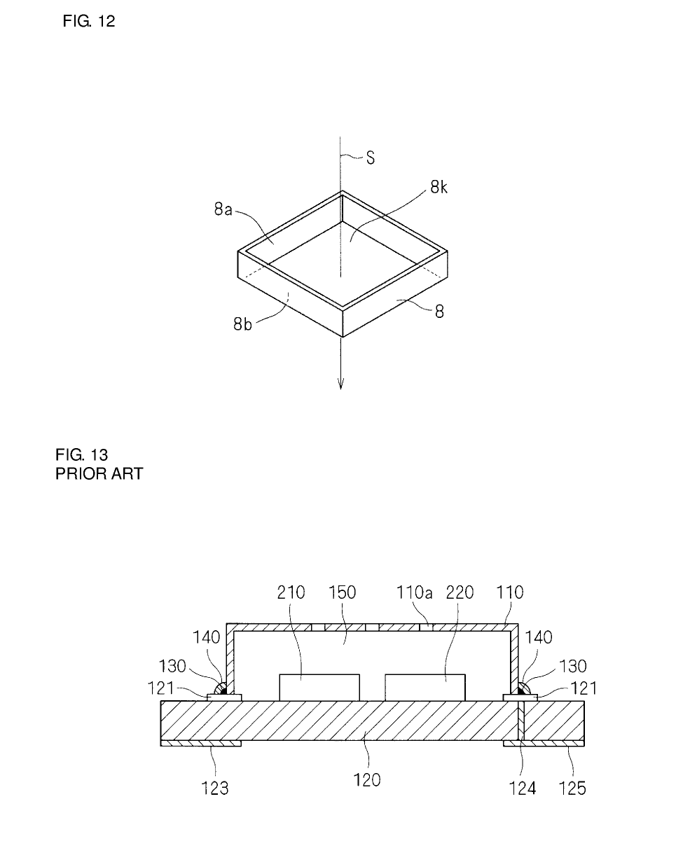

FIG. 11 is a graph showing the attenuation characteristic of the cylindrical electromagnetic shield member. More specifically, this graph shows a result of simulation of the attenuation characteristic of a cylindrical electromagnetic shield member 8, having apertures 8a and 8b at opposite ends, performed when an electromagnetic wave travels through an inner space 8k of the electromagnetic shield member 8 from one aperture 8a to the other aperture 8b in an axial direction shown by arrow S, as illustrated in FIG. 12 serving as a perspective view. Here, the apertures 8a and 8b have a size of 2 mm×2 mm, and the electromagnetic shield member 8 has a height of 0.2 mm and is formed of gold.

FIG. 11 shows that attenuation of the electromagnetic wave passing in the axial direction of the cylinder shown by arrow S in FIG. 12 increases as the frequency decreases in a low-frequency band of 50 kHz or less and that attenuation of 20 dB or more can be obtained. Since, for example, the sampling frequency of voice in music CDs, satellite broadcasting, and DVDs is lower than 50 kHz, a sufficient electromagnetic shield effect can be obtained by using the cylindrical electromagnetic shield member 40 in the acoustic transducer unit 10, without placing electromagnetic shield members formed of a conductive material at or near the apertures 40s and 40t provided at the opposite ends of the electromagnetic shield member 40. As the material of the cylindrical electromagnetic shield member, gold has a more beneficial effect on attenuation of the electromagnetic wave than other metals. For example, when a given attenuation is obtained, an electromagnetic shield formed of gold is more suitable than electromagnetic shields formed of other metals because it can have a small size. Here, the shape of the electromagnetic shield member in the embodiment of the present invention is not limited to the rectangular cylindrical shape illustrated in FIG. 12, and for example, a circular cylindrical electromagnetic shield member may be used.

For example, when a gap of 0.2 mm is formed between an upper surface 4a (see FIG. 2(a)) of the acoustic transducer portion 4 in the microphone element 2 and the upper aperture 40s (see FIG. 1) of the electromagnetic shield member 40, an electromagnetic wave, which travels from the upper aperture 40s of the electromagnetic shield member 40 toward the acoustic transducer portion 4 of the microphone element 2, is attenuated by 20 dB or more until it reaches the upper surface 4a of the acoustic transducer portion 4 in the microphone element 2. Similarly, when a gap of 0.2 mm is formed between a lower surface 4b (see FIG. 2(a)) of the acoustic transducer portion 4 in the microphone element 2 and the lower aperture 40t (see FIG. 1) of the electromagnetic shield member 40, an electromagnetic wave, which travels from the lower aperture 40t of the electromagnetic shield member 40 toward the acoustic transducer portion 4 in the microphone element 2, is attenuated by 20 dB or more until it reaches the lower surface 4b of the acoustic transducer portion 4 in the microphone element 2. As a result, the electromagnetic wave passing through the acoustic transducer portion 4 of the microphone element 2 and having a frequency lower than 50 kHz, which is used as the sampling frequency of voice in music CDs, satellite broadcasting, and DVDs, attenuates by 20 dB or more. Hence, a sufficient electromagnetic shield effect can be obtained as the acoustic transducer unit.

Preferably, the entire microphone element 2 is completely housed in the inner space 40k defined by the electromagnetic shield member 40. In this case, the peripheral circuit and so on in the microphone element 2 can also be shielded electromagnetically. More preferably, in an acoustic transducer unit shaped like a flat plate having a principal surface, such as a MEMS microphone, an EMC, or a piezoelectric microphone, for example, when the thickness of a mechanical-electrical transducer of the MEMS microphone for mutually converting acoustic vibration and an electrical signal is 0.1 mm, the principal surface of the acoustic transducer unit perpendicularly intersects the center axis of a cylinder shown by arrow S in FIG. 12, and only a cylindrical electromagnetic shield member having the total height of 0.5 mm is formed such as to have a height of 0.2 mm on each of the upper and lower sides of the mechanical-electrical transducer in the thickness direction. This allows the acoustic transducer unit to have a sufficient electromagnetic shield effect, and therefore, height reduction is easy.

For example, when a gap of 0.2 mm is formed between an upper surface 2a (see FIG. 2) of the microphone element 2 and the upper aperture 40s (see FIG. 1) of the electromagnetic shield member 40 and a gap of 0.2 mm is formed between a lower surface 2b (see FIG. 2) of the microphone element 2 and the lower aperture 40t (see FIG. 1) of the electromagnetic shield member 40, an electromagnetic shield effect of 20 dB or more can also be obtained for the peripheral circuit and so on in the microphone element 2.

Since it is unnecessary to cover the entire periphery of the microphone element in the acoustic transducer unit 10, the structure can be simplified and the production cost can be reduced. Moreover, size reduction is easy.

In the acoustic transducer unit 10, the structure in which the electromagnetic shield member 40 is buried in the resin main body of the first member 30 can be produced at low cost by insert molding, and size reduction is easy.

Further, since the microphone element 2 is mounted face down in the acoustic transducer unit 10, a bonding wire space is unnecessary, and a lower size and a smaller height can be obtained than when it is mounted face up. Moreover, since the capacity for bonding wire is unnecessary, the optimum acoustic design can be achieved.

When the first member 30 and the second member 20 are formed of only resin, the force for bonding the members, for example, with adhesive or by heat welding can be greater than the force for bonding metal and resin, which are different materials each other, for example, with adhesive or heat welding. Particularly when the first member 30 and the second member 20 are formed of the same resin material and are bonded by heat welding such as ultrasonic welding, the force for bonding can be increased because affinity of the material is high.

When the cylindrical electromagnetic shield member 40 is buried in the first member 30 formed of a resin material, it is unnecessary to form a conductive material serving as an electromagnetic shield member in the first member 30 and the second member 20, for example, by adhesion, plating, or baking. Hence, the degree of flexibility in designing the resin material is higher and the production process is simpler than when a conductive member, such as metal, is formed as an electromagnetic shield member in the first member 30 and the second member 20 of the resin material

by adhesion, plating, or baking.

### Second Embodiment

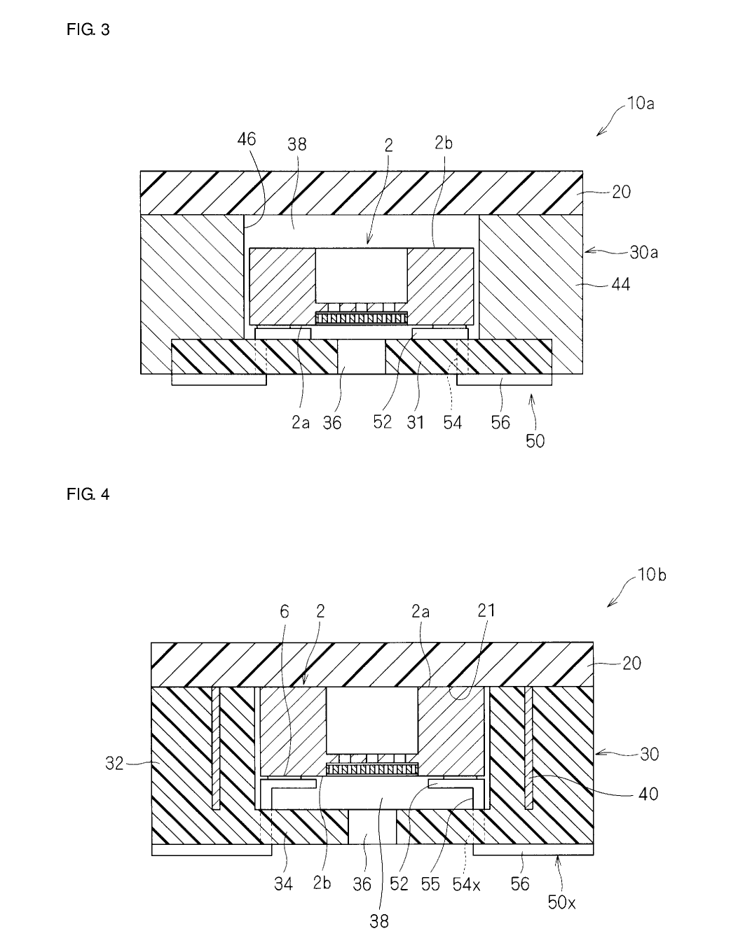

An acoustic transducer unit 10a according to a second embodiment will be described with reference to FIG. 3.

The acoustic transducer unit 10a of the second embodiment has a structure substantially similar to that of the acoustic transducer unit 10 of the first embodiment. The following description will be given with a focus on differences from the first embodiment, and the same structures as those adopted in the first embodiment are denoted by the same reference numerals.

FIG. 3 is a cross-sectional view of the acoustic transducer unit 10a of the second embodiment. As illustrated in FIG. 3, in the acoustic transducer unit 10a, a microphone element 2 is stored in a housing defined by a first member 30a and a second member 20, similarly to the acoustic transducer unit 10 of the first embodiment. However, the acoustic transducer unit 10a is different from the acoustic transducer unit 10 of the first embodiment in the structure of the first member 30a.

That is, in the first member 30a, a bottom wall member 31 is bonded to one end of a cylindrical side wall member 44 having a through-hole 46, for example, with adhesive so as to close one aperture of the through-hole 46. This forms a concave portion 38 in the first member 30a.

The side wall member 44 has a circular or rectangular normal section. The side wall member 44 is entirely formed of a conductive material such as metal. That is, the side wall member 44 is a cylindrical conductive portion formed of a conductive material and having an inner space with both end apertures.

The bottom wall member 31 is a nonconductive portion formed of only an insulating material such as resin. The bottom wall member 31 is provided with terminal members 50. The terminal members 50 are formed integrally with the bottom wall member 31 by insert molding, and middle portions 54 of the terminal members 50 are buried in the bottom wall member 31.

The microphone element 2 is mounted on the bottom wall member 31, and connecting terminals 6 of the microphone element 2 are connected to internal terminal portions 52 of the terminal members 50.

The second member 20 formed of only an insulating material, such as resin, is bonded to the other end of the side wall member 44, for example, with adhesive or by heat welding, and the other aperture of the through-hole 46 of the side wall member 44 is covered with the second member 20, whereby the microphone element 2 is sealed.

The cylindrical side wall member 44 entirely formed of a conductive material can serve an electromagnetic shield function, similarly to the electromagnetic shield member 40 of the first embodiment. That is, since the side wall member 44 is formed of a conductive material, it can cut off an electromagnetic wave to pass therethrough. As for an electromagnetic wave passing through the through-hole of the side wall member, a component thereof in the low-frequency band related to sound can be sufficiently attenuated by appropriately selecting the dimensions and shape of the side wall member 44. Therefore, it is possible to cut off an electromagnetic interference signal that causes noise in the microphone element 2.

### Third Embodiment

An acoustic transducer unit 10b according to a third embodiment will be described with reference to FIG. 4.

The acoustic transducer unit 10b of the third embodiment has a structure substantially similar to that of the acoustic transducer unit 10 of the first embodiment. However, unlike the embodiment 1, a microphone element 2 is pressed against a lower surface 21 of a second member 20.

That is, middle portions 54x connecting internal terminal portions 52 and external terminal portions 56 of terminal members 50x have portions 55 projecting in a concave portion 38 in a manner such that the internal terminal portions 52 are suspended above a bottom portion 34. The microphone element 2 is supported while being suspended above the bottom portion 34 with connecting terminals 6 being connected to the internal terminal portions 52. In this case, the microphone element 2 is mounted with an upper surface 2a slightly projecting from an upper surface of a first member 30. When the second member 20 is bonded to the first member 30 later, the microphone element 2 is pushed down by the lower surface 21 of the second member 20. With this, the portions 55 of the terminal members 50x projecting in the concave portion 38 elastically deform, and the microphone element 2 is biased toward the second member 20. As a result, the upper surface 2a of the microphone element 2 is kept pressed up against the lower surface 21 of the second member 20.

Since the terminal members 50x have such springiness, even some variations in the component dimensions, such as the height of the microphone element 2, the depth of the concave portion 38 of the first member 30, and the height of the portions 55 of the terminal members 50x projecting in the concave portion 38, can be absorbed. Further, since the microphone element 2 is in pressing contact with the second member 20, airtightness is enhanced, degradation of the sensitivity characteristic due to sound leakage can be avoided, and characteristic variations can be reduced.

### Fourth Embodiment

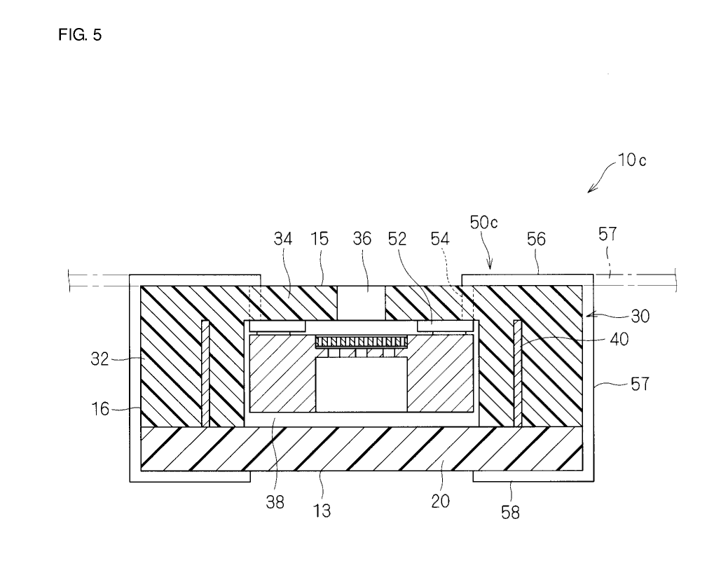

An acoustic transducer unit 10c according to a fourth embodiment will be described with reference to FIG. 5.

As illustrated in FIG. 5 serving as a cross-sectional view, in the acoustic transducer unit 10c of the fourth embodiment, external terminal portions 58 for connecting the acoustic transducer unit 10c to an external circuit are provided on a surface 13 of a second member 20

opposite a surface 15 of a first member 30.

That is, belt-shaped other end portions 56, 57, and 58 of terminal members 50c extending to the outside through the first member 30 are folded along outer peripheral surfaces of the first member 30 and the second member 20, and the external terminal portions 58 for connecting the acoustic transducer unit 10c to the external circuit are provided on the surface 13 of the second member 20.

To produce the acoustic transducer unit 10c of the fourth embodiment, a resin main body of the first member 30, an electromagnetic shield member 40, and the terminal members 50c are integrally formed by insert molding, similarly to the acoustic transducer unit 10 of the first embodiment, in a state in which the other end portions 56, 57, and 58 of the terminal members 50c extend straight, as shown by broken lines. After a microphone element 2 is mounted in a concave portion 38 of the first member 30 and the second member 20 is bonded to the first member 30, the other end portions 56, 57, and 58 of the terminal members 50c are folded.

The acoustic transducer unit 10c of the fourth embodiment can share the components with the acoustic transducer unit 10 of the first embodiment, and it is only necessary to change the position where the terminal members are cut after insert molding. For this reason, a plurality of types of acoustic transducer units that are different in the arrangement of the external terminal portions can be produced at low cost.

First Modification

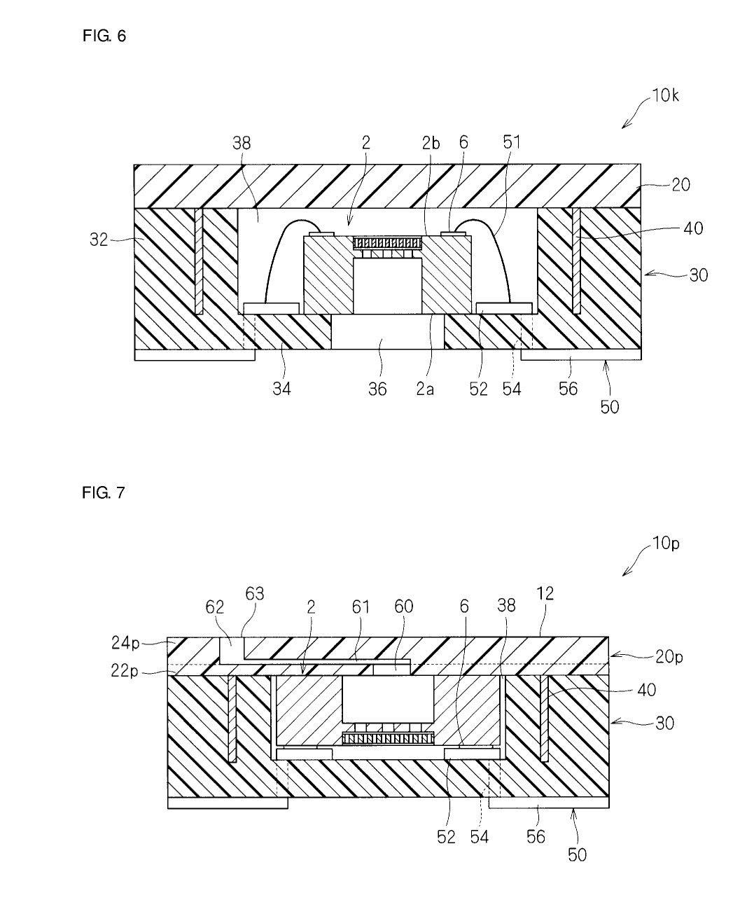

An acoustic transducer unit 10k according to a first modification will be described with reference to FIG. 6.

As illustrated in FIG. 6 serving as a cross-sectional view, the acoustic transducer unit 10k of the first modification is mounted face up, unlike the acoustic transducer unit 10 of the first embodiment.

That is, a microphone element 2 is set in a concave portion 38 of a first member 30 with connecting terminals 6 facing up, and the connecting terminals 6 of the microphone element 2 are connected to internal terminal portions 52 of terminal members 50 by bonding wires 51, for example, formed of Au.

According to this face-up structure, mounting of the microphone element is more technically easy and less expensive equipment can be used, than in the face-down structure. Therefore, the production cost can be reduced.

Second Modification

An acoustic transducer unit 10p according to a second modification will be described with reference to FIG. 7.

As illustrated in FIG. 7 serving as a cross-sectional view, an aperture 63 of an acoustic path is provided in an upper surface 12 of the acoustic transducer unit 10p of the second modification. A second member 20p has folded acoustic paths 60, 61, and 62 that communicate between the aperture 63 and a concave portion 38 in which a microphone element 2 is stored.

For example, the acoustic paths 60, 61, and 62 can be formed by bonding an upper layer member 24p having a through-hole 62 and a bottomed groove 61 to a lower layer member 22p having a through-hole 60.

In the acoustic transducer unit 10p of the second modification, the acoustic paths 60, 61, and 62 can be easily formed with high form accuracy, for example, by boring, grooving, and sticking the plate materials.

Third Modification

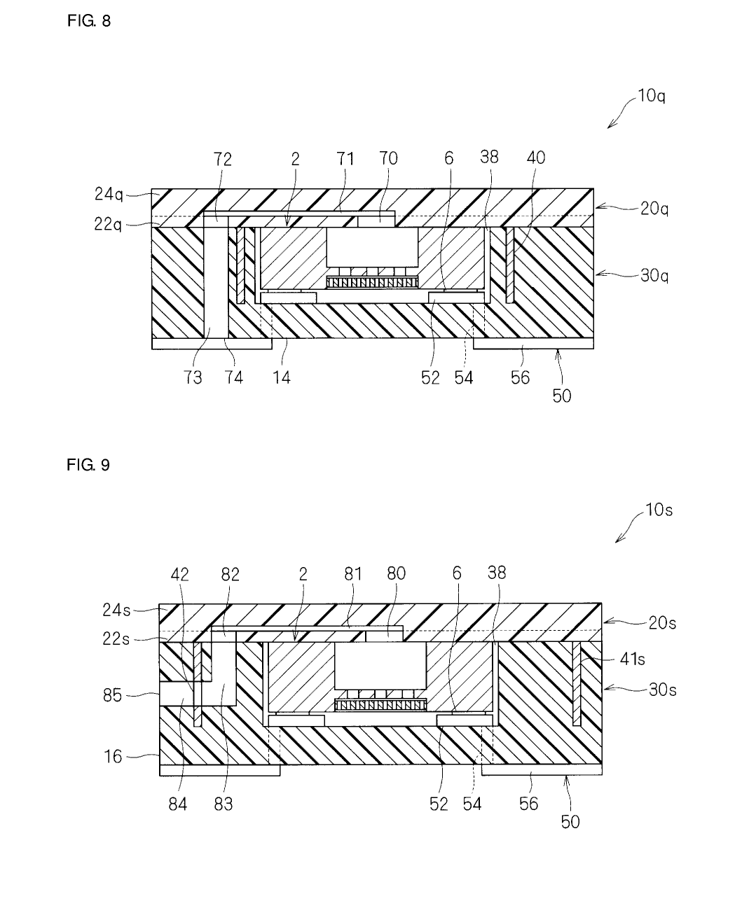

An acoustic transducer unit 10q according to a third modification will be described with reference to FIG. 8.

As illustrated in FIG. 8 serving as a cross-sectional view, an aperture 74 is provided in a lower surface 14 of the acoustic transducer unit 10q of the third modification. A first member 30q and a second member 20q have folded acoustic paths 70 to 73 that communicate between the aperture 74 and a concave portion 38 in which a microphone element 2 is stored.

For example, the acoustic paths 70 to 72 are formed in the second member 20q by bonding an upper layer member 24q having a bottomed groove 71 to a lower layer member 22q having through-holes 70 and 72. In this case, acoustic paths can be easily formed with high form accuracy, for example, by boring, grooving, and sticking the plate materials.

The acoustic path 73 of the first member 30q is formed simultaneously with formation of the first member 30q, for example, by insert molding. In this case, the acoustic path 73 can be formed with high form accuracy.

Fourth Modification

An acoustic transducer unit 10s according to a fourth modification will be described with reference to FIG. 9.

As illustrated in FIG. 9 serving as a cross-sectional view, an aperture 85 is provided in a side surface 16 of the acoustic transducer unit 10s of the fourth modification. A first member 30s and a second member 20s have folded acoustic paths 80 to 84 that communicate between the aperture 85 and a concave portion 38 in which a microphone element 2 is stored.

For example, the acoustic paths 80 to 82 are formed in the second member 20s by bonding an upper layer member 24s having a bottomed groove 81 to a lower layer member 22s having through-holes 80 and 82. In this case, the acoustic paths 80 to 83 can be easily formed with high form accuracy, for example, by boring, grooving, and sticking the plate materials.

The acoustic paths 83 and 84 of the first member 30s are formed simultaneously with formation of the first member 30s, for example, by insert molding. In this case, the acoustic paths 83 and 84 can be formed with high form accuracy.

A cylindrical electromagnetic shield member 41s formed of a conductive material and having an inner space, where a microphone element 2 is stored, has a through-hole 42 so that the acoustic path 84 is not closed. Since the through-hole 42 is entirely surrounded by the conductive material, it is possible to prevent degradation of an electromagnetic shield effect.

Fifth Modification

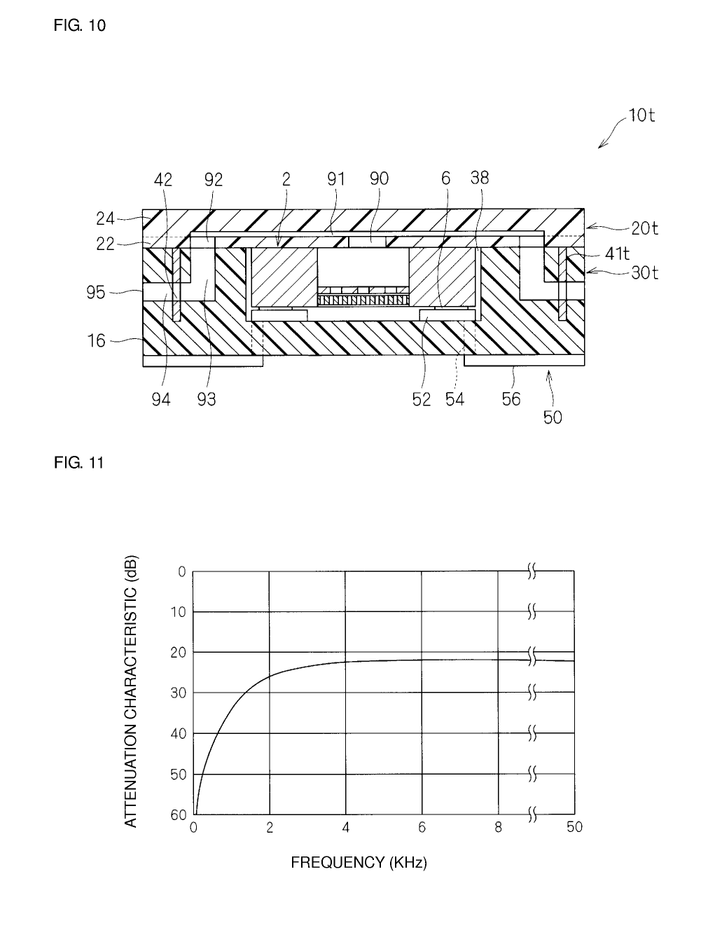

An acoustic transducer unit 10t according to a fifth modification will be described with reference to FIG. 10.

A plurality of apertures 95 are provided in a side surface 16 of the acoustic transducer unit 10t of the fifth modification illustrated in FIG. 10 serving as a cross-sectional view. A first member 30t and a second member 20t have folded acoustic paths 90 to 94 that communicate between the apertures 95 and a concave portion 38 in which a microphone element 2 is stored.

For example, the acoustic paths 90 to 92 are formed in the second member 20t by bonding an upper layer member 24 having a bottomed groove 91 to a lower layer member 22 having a through-hole 90 and a plurality of through-holes 92. In this case, the acoustic paths 90 to 93 can be easily formed with high form accuracy, for example, by boring, grooving, and sticking the plate materials.

A plurality of pairs of acoustic paths 93 and 94 are formed in the first member 30t simultaneously with formation of the first member 30t, for example, by insert molding. In this case, the acoustic paths 93 and 94 can be formed with high form accuracy.

A cylindrical electromagnetic shield member 41t formed of a conductive material and having an inner space, where the microphone element 2 is stored, has through-holes 42 so that the acoustic paths 94 are not closed. Since the through-holes 42 are entirely surrounded by the conductive material, it is possible to prevent degradation of an electromagnetic shield effect.

### CONCLUSION

As described above, the microphone element can be electromagnetically shielded with a simple structure by being stored in the inner space of the cylindrical electromagnetic shield member having both end apertures. For this reason, the production cost, size, and height can be reduced easily.

The present invention is not limited to the above-described embodiments, and can be carried out by various modifications.

The microphone element can be stored in an arbitrary orientation in the inner space of the electromagnetic shield member or the side wall member. For example, in FIG. 2(b), the microphone element can be stored in a different orientation.

A conductive portion may be provided on an outer peripheral surface of the first member or an inner peripheral surface of the concave portion. The conductive portion may be formed by a method different from the methods of the embodiments, for example, by plating.

The electromagnetic shield member and the side wall member may be grounded. For example, the electromagnetic shield member may be grounded by extending a part of the electromagnetic shield member and electrically connecting the extended part to the terminal member, or forming an external terminal portion by the extended part of the electromagnetic shield member. Similarly, the side wall member may be grounded by electrically connecting the side wall member to the terminal member or projecting a part of the side wall member to form an external terminal portion.

### REFERENCE NUMBER LIST

2: microphone element (acoustic transducer)
4: acoustic transducer portion
6: connecting terminal
10, 10a, 10b, 10c, 10k, 10p, 10q, 10s, 10t: acoustic transducer unit
20, 20p, 20q, 20s, 20t: second member (package, nonconductive portion)
30, 30a, 30q, 30s, 30t: first member (package)
31: bottom wall member (nonconductive portion)
32: cylindrical portion
34: bottom portion (nonconductive portion)
38, 30a: concave portion
40: electromagnetic shield member (conductive portion)
40k: inner space
40s, 40t: aperture
41s, 41t: electromagnetic shield member (conductive portion)
44: side wall member (conductive portion)
50, 50x: terminal member
52: internal terminal portion (one end portion)
54, 54x: middle portion
55: projecting portion (one end portion)
56, 57, 58: other end portion

1. An acoustic transducer unit comprising:
an acoustic transducer having an acoustic transducer portion that converts sound into an electrical signal or converts an electrical signal into sound; and
a package that accommodates the acoustic transducer,
wherein the package includes a cylindrical conductive portion having an inner space with two opposed end apertures, and
wherein at least the acoustic transducer portion of the acoustic transducer is located in the inner space of the cylindrical conductive portion so as to be spaced from the apertures.

2. The acoustic transducer unit according to claim 1, wherein the cylindrical conductive portion is buried in a resin main body of the package.

3. The acoustic transducer unit according to claim 1, wherein the entire acoustic transducer is located in the inner space of the cylindrical conductive portion.

4. The acoustic transducer unit according to claim 1,
wherein the package includes:
a first member having a concave portion in which the acoustic transducer is provided;
a second member connected to the first member to cover the concave portion; and
a terminal member extending through the first member, and having a first end portion projecting in the concave portion and electrically connected to the acoustic transducer and a second end portion exposed outside the first member.

5. The acoustic transducer unit according to claim 4, wherein the first end portion of the terminal member projecting in the concave portion elastically deforms to press the acoustic transducer against the second member.

6. The acoustic transducer unit according to claim 1,
wherein the package includes:
a first member having a concave portion in which the acoustic transducer is provided,
a second member having a pair of principal surfaces, a first of the pair of principal surfaces being connected to the first member to cover the concave portion; and
a terminal member extending through the first member, and having a first end portion thereof projecting in the concave portion and electrically connected to the acoustic transducer and a second end portion thereof exposed outside the first member, and
wherein the second end portion of the terminal member extends along outer peripheral surfaces of the first member and the second member to a second of the pair of principal surfaces of the second member.

7. The acoustic transducer unit according to claim 1, wherein the package further includes a nonconductive portions formed of an insulating material that cover the two opposed apertures.

8. The acoustic transducer unit according to claim 7, wherein the conductive portion is buried in a resin main body of the package.

9. The acoustic transducer unit according to claim 7,
wherein the package includes:
a first member having a concave portion in which the acoustic transducer is provided; and
a plate-shaped second member formed of the insulating material and connected to the first member so as to cover an aperture of the concave portion,
wherein the package includes a terminal member extending through the first member, and having a first end portion thereof projecting in the concave portion and electrically connected to the acoustic transducer and a second end portion exposed thereof outside the first member, and
wherein the one end portion of the terminal member projecting in the concave portion elastically deforms to press the acoustic transducer against the second member.

10. The acoustic transducer unit according to claim 9, wherein the second end portion of the terminal member projecting in the concave portion elastically deforms to press the acoustic transducer against the second member

11. The acoustic transducer unit according to claim 7,
wherein the package includes:
a first member having a concave portion in which the acoustic transducer is provided; and
a second member having a pair of principal surfaces, a first of the pair of principal surfaces being connected to the first member to cover the concave portion,
wherein the package includes a terminal member extending through the first member, and having a first end portion thereof projecting in the concave portion and electrically connected to the acoustic transducer and a second end portion thereof exposed outside the first member, and
wherein the second end portion of the terminal member extends along outer peripheral surfaces of the first member and the second member to a second of the pair of principal surfaces of the second member.

12. The acoustic transducer unit according to claim 1, further comprising at least one acoustic path between the inner space of the package and an outer surface of the package.
